(19) United States
(12) Patent Application Publication
(10) Pub. No.: US 2017/0064099 A1
(43) Pub. Date: Mar. 2, 2017

(54) TRAIL CAMERA MEMORY CARD VIEWER

(71) Applicants: Alphons John Kaiser, Wausau, WI (US); Joshua Lee Caraway, Mosinee, WI (US)

(72) Inventors: Alphons John Kaiser, Wausau, WI (US); Joshua Lee Caraway, Mosinee, WI (US)

(21) Appl. No.: 15/252,650

(22) Filed: Aug. 31, 2016

Related U.S. Application Data
(60) Provisional application No. 62/212,848, filed on Sep. 1, 2015.

(51) Int. Cl. H04N 1/00; G06F 3/041; G06F 3/01

(52) U.S. Cl. CPC H04N 1/00161; G06F 3/016; G06F 3/0412; H04N 1/00172; H04N 2201/0089; H04N 2201/0087; H04N 2201/0096

(57) ABSTRACT

A trail camera memory card viewer is provided. The trail camera memory card viewer has a user interface for reproducing digital images from a coupled trail camera memory card, wherein the user interface provides a nine-inch screen and a plurality of haptic setting and image-manipulating buttons for studying and editing the trail camera pictures and videos. The trail camera memory card viewer has no Internet connectivity, drastically shortening the time to view and examine pictures and videos from a user's trail camera.

### CROSS-REFERENCE TO RELATED APPLICATION

This application claims the benefit of priority of U.S. provisional application number 62/212,848, filed 01 Sep. 2015, the contents of which are herein incorporated by reference.

### BACKGROUND OF THE INVENTION

The present invention relates to managing trail camera accessories and, more particularly, a trail camera memory card viewer.

A trail camera is a camera placed by a hunter, outdoors person, or photographer in areas where the person generally cannot be. The trail camera is designed for extended and unmanned use outdoors, wherein the trail camera records images, either as a still photograph or a video, for extended lengths of time. These images are stored on a memory card, from which the images are viewable on a memory card viewer.

As a result of capturing images for an extended period of time there are voluminous amounts of images to be viewed when the trail camera memory card is retrieved from the trail camera. Unfortunately, current trail camera memory card viewers—viewers compatible with memory cards used to store images or data in the digital trail camera, such as secure digital (SD) cards—are very slow and have smaller screens, making it hard to view and operate. In essence, they are not designed to view and examine the thousands of pictures and videos that can be captured by a trail camera in a reasonable amount of time.

One portion of problem is that these current memory card viewer devices are beholden to Internet connectivity, slowing performance and extending the time it takes a user to view and examine the pictures and videos of the trail camera. Another part of the problem is that current memory card viewer devices provide a small viewing screen and operate with toggle switches to move and enlarge pictures, further undermining the viewing rate and pleasure of the user.

As can be seen, there is a need for a trail camera memory card viewer having no Internet connectivity, providing a large viewing screen that is totally touch-screen operable so as to view trail camera images three times faster than any current trail camera memory card viewer.

### SUMMARY OF THE INVENTION

In one aspect of the present invention, a trail camera memory card viewer includes a computer having at least one processor coupled to a form of memory and a touchscreen user interface for reproducing digital images, wherein the user interface provides a plurality of haptic buttons for manipulating said reproduced digital images; and at least one memory card port coupled to the computer, wherein the computer has no Internet connectivity.

In another aspect of the present invention, the trail camera memory card viewer includes a computer having at least one processor coupled to a form of memory and a touchscreen user interface for reproducing digital images; the user interface provides a haptic settings button, a haptic gallery button, and a haptic brightness adjustment button for manipulating said reproduced digital images, wherein the touchscreen user interface has a nine-inch display size; two memory card ports of different sizes coupled to the computer; a HDMI port coupled to the computer; and a USB port coupled to the computer, wherein the computer has no Internet connectivity.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention; and

FIG. 3 is a perspective view of an exemplary embodiment of the present invention, illustrated without a protective case component.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a trail camera memory card viewer having a user interface for reproducing digital images from a coupled trail camera memory card. The user interface provides a nine-inch screen and a plurality of haptic setting and image-manipulating buttons for studying and editing the trail camera pictures and videos. The trail camera memory card viewer has no Internet connectivity, drastically shortening the time to view and examine pictures and videos from a user's trail camera.

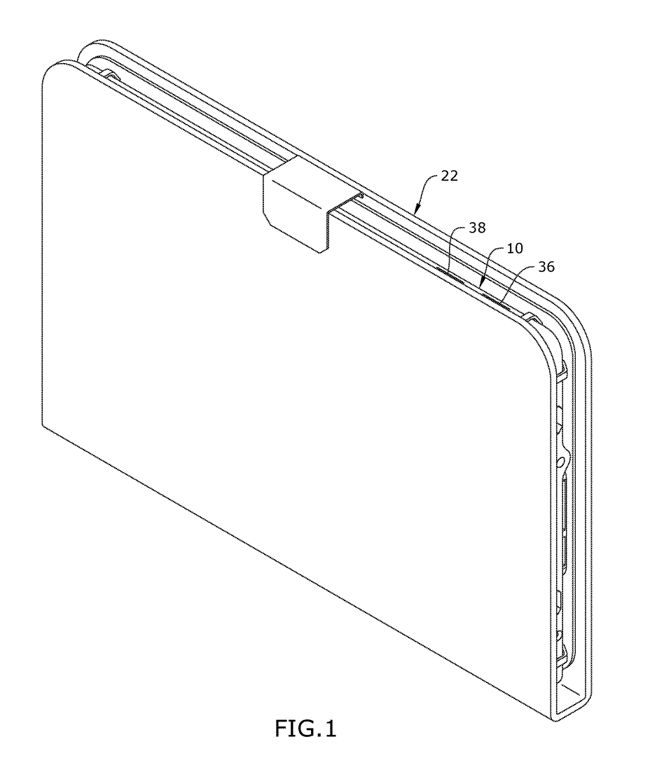

Referring now to FIGS. 1 through 3, the present invention may include a trail camera memory card viewer 10, an electronic device having at least one processor coupled to a form of memory and having a user interface 26 for reproducing digital images from a trail camera memory card (not shown). The electronic device can be removably coupled to full size and micro memory cards, micro or mini audio/video interfaces for transferring compressed or uncompressed digital data (HDMI), power sources, and connectors to computer memory cardsvia SD ports 12 and 14, HDMI ports 16, power ports 18, and USB ports 20, respectively.

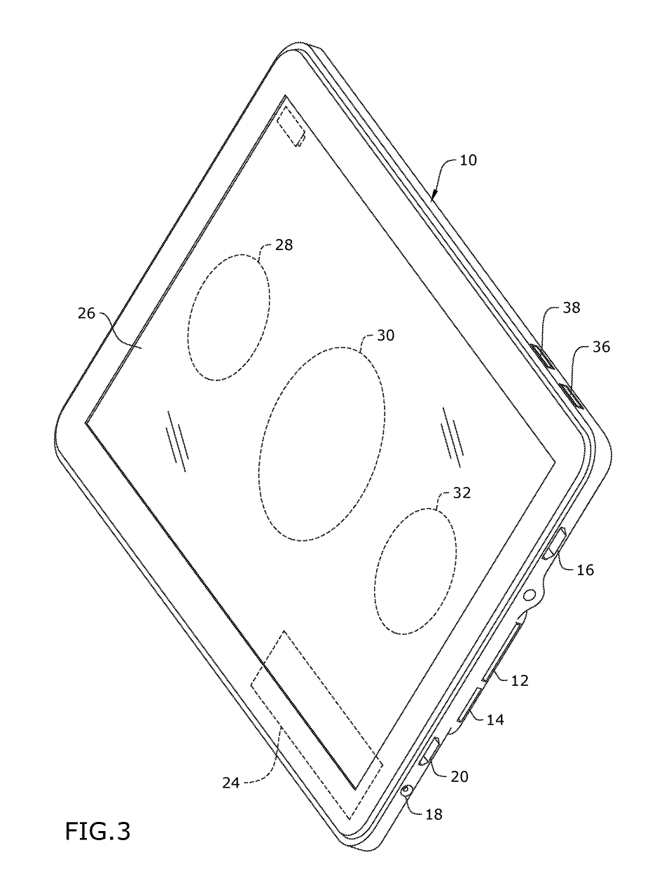

The user interface 26 may include a nine-inch touchscreen adapted to move, edit, manipulate, reduce, enlarge, saves, and deletes pictures and videos stored on the trail camera memory card. To that end, the user interface 26 may provide haptic settings button 28, gallery button 30, brightness adjustment button 32, and other image-manipulating buttons, as illustrated in FIG. 3. The nine-inch touchscreen may have a display size (or viewable image size or VIS) of nine inches, defined by the length of its diagonal which is the distance between opposite corners.

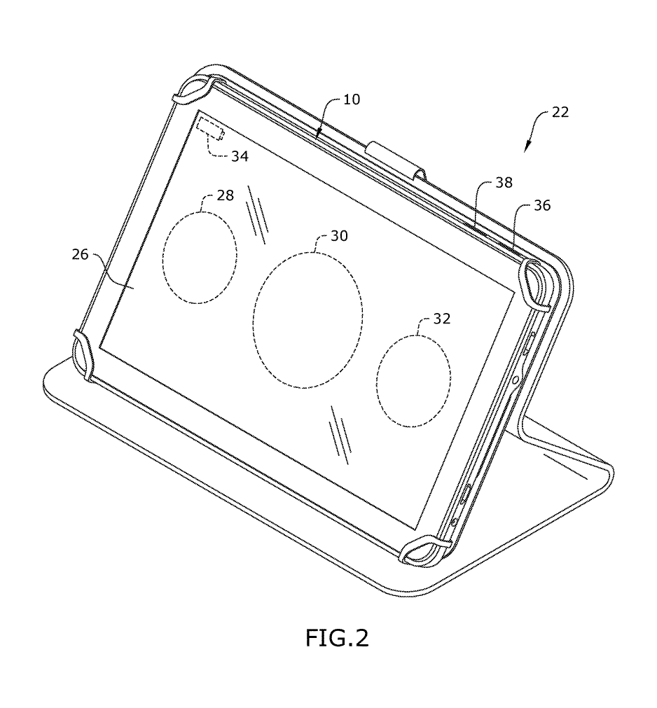

The viewer 10 may incorporate a power button 36 and a volume button 38. The viewer 10 may incorporate a rechargeable battery source 24, such as a lithium-ion battery and the like. The user interface 26 may be adapted to display a power indicator representation 34, as illustrated in FIG. 2. The viewer may include a protective screen cover for the user interface 26, and a protective case 22 for the viewer 10 itself, as illustrated in FIGS. 1 and 2.

A method of using the present invention may include the following. The trail camera memory card viewer 10 disclosed above may be provided. A user may remove the trail camera memory card from the trail camera, and then insert the former into SD port 12, and then load the pictures and videos quickly onto the viewer 10. Once the viewer 10 has the pictures and videos loaded, the user can then study, manipulate, and edit the pictures and videos on the nine-inch touch screen user interface 26 using the haptic settings button 28, gallery button 30, brightness adjustment button 32, and other image-manipulating buttons. If the user chooses to save the pictures and/or videos, raw or edited, they can select and save them to the micro SD card, after it is inserted into the micro SD card port 14. Also the user can view the pictures and/or videos through the HDMI port 16, which allows for the attachment to an external screen.

Additionally: The present invention may be used in the same manner as to view non-trail camera pictures and videos; for example, for watching movies, viewing picture albums, slideshow presentations, and the like.

The viewer 10 is lightweight and portable, and loads and views the pictures and/or videos from trail camera memory card three times faster than any other similar product as it has no Internet connectivity (no wifi, no 4g, no internet, no email) to slow it down, drastically shortening the time to view and examine pictures and videos from a user's trail camera.

It should be understood, of course, that the foregoing relates to exemplary embodiments of the invention and that modifications may be made without departing from the spirit and scope of the present invention.

What is claimed is:

1. A trail camera memory card viewer, comprising:
a computer having at least one processor coupled to a form of memory and a touchscreen user interface for reproducing digital images, wherein the user interface provides a plurality of haptic buttons for manipulating said reproduced digital images; and
at least one memory card port coupled to the computer,
wherein the computer has no Internet connectivity.

2. The trail camera memory card viewer of claim 1, wherein the touchscreen user interface has a nine-inch display size.

3. The trail camera memory card viewer of claim 1, wherein at least one memory card port includes two memory card ports of two different sizes.

4. The trail camera memory card viewer of claim 1, wherein the plurality of haptic buttons comprises a settings button, a gallery button, and brightness adjustment button.

5. The trail camera memory card viewer of claim 1, further comprising a HDMI port coupled to the computer.

6. The trail camera memory card viewer of claim 1, further comprising a USB port coupled to the computer.

7. A trail camera memory card viewer, comprising:
a computer having at least one processor coupled to a form of memory and a touchscreen user interface for reproducing digital images;
the user interface provides a haptic settings button, a haptic gallery button, and a haptic brightness adjustment button for manipulating said reproduced digital images, wherein the touchscreen user interface has a nine-inch display size;
two memory card ports of different sizes coupled to the computer;
a HDMI port coupled to the computer; and
a USB port coupled to the computer, wherein the computer has no Internet connectivity.
